(19) United States
(12) Patent Application Publication
(10) Pub. No.: US 2004/0010905 A1
(43) Pub. Date: Jan. 22, 2004

(54) Termination tool

(76) Inventors: Friedhelm Denter, Castrop-Rauxel (DE); Hans-Dieter Otto, Wipperfurth (DE); Norbert Gaertner, Wuppertal (DE)

Correspondence Address: FINNEGAN, HENDERSON, FARABOW, GARRETT & DUNNER, LLP, 1300 I STREET, NW, WASHINGTON, DC, 20005, US

(21) Appl. No.: 10/399,685

(22) PCT Filed: Oct. 23, 2001
(86) PCT No.: PCT/EP01/12236

(30) Foreign Application Priority Data
Oct. 23, 2000 (DE) 200 18 103.3

(51) Int. Cl. B23P 23/00

(52) U.S. Cl. 29/566.4; 29/758

(57) ABSTRACT

A termination tool for terminating cable cores in telecommunications module contacts, comprises a handle, a jig for receiving the cores and stuffing them into a contact, and a trimmer (10) on said jig, wherein said trimmer (10) is at least double-acting, so that at least two cable cores can be trimmed to length in a single operation.

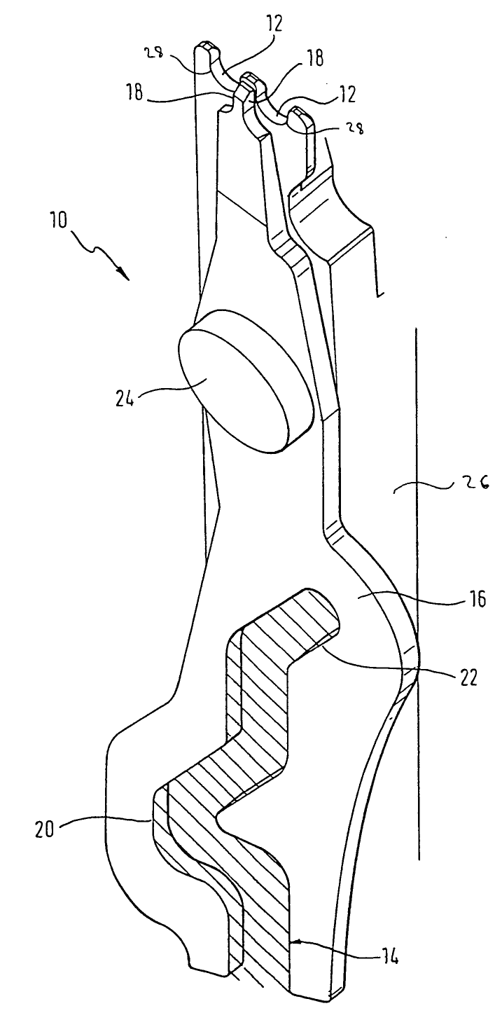

### TECHNICAL FIELD

The invention relates to a termination tool for terminating cable cores in telecommunications module contacts.

In telecommunications engineering, cable cores are interconnected by terminating them at modules comprising contacts which are usually insulation displacement contacts (IDC). The cable cores are terminated by stuffing them into the contacts so that the sharp cutting edges of the insulation displacement contacts bite through the insulation of the cable cores to subsequently conductively contact the wire conductor of the cable core.

### BACKGROUND

A termination tool is described in DE 298 14 484 U1. This termination tool comprises a handle and jig on which a trimmer is provided. The trimmer is configured so that a cable core can be trimmed to length by nipping and severing it between two blades which cooperate on a side-cutter principle. The trimmer is configured so that precisely one cable core can be trimmed after being stuffed into the contact. The termination tools otherwise described in the art likewise feature trimmers which are configured for trimming just one cable core at a time.

### SUMMARY OF THE INVENTION

The invention provides a termination tool in accordance with a handle, a jig for receiving the cores and stuffing them into a contact, and a trimmer on the jig. The trimmer is at least double-acting so that at least two cable cores can be stuffed and trimmed in a single operation. In other words, in terminating cable cores on a module, at least two cable cores can be located in suitable guide means on the jig, stuffed into their respective contacts and then trimmed to length by a trimmer. This is achievable for example, by a movable blade with sharp edges on two opposite sides, wherein the blade is first pivoted to one side to make the first trim in cooperation with a fixed blade, and then, pivoted (during continuation of the stroke) to the other side to make the second trim with the opposite cutting edge in cooperation with a further fixed cutting edge.

With the invention, the time required for circuiting a complete module can be practically halved, since two cable cores can be stuffed in their corresponding contacts and trimmed in a single operation. The embodiment described above merely requires the stroke for operating the trim on two cores be configured longer. However, this drawback, too, can be avoided by a preferred embodiment in which two blades are moved simultaneously against separate fixed blades to simultaneously trim two cable cores. In this embodiment, the stroke is shorter, and although the force needed to make two trims is higher than that for a single trim, the needed cutting force can be applied manually.

Although the so-called “side-cutting principle” (i.e. two blades are urged together such that trimming occurs between the two cutting edges, when they contact with each other) can be used, more preferably, the invention employs a “scissors action” (i.e., one movable blade cooperates with a fixed edge on the jig, causing a cut when they closely pass by each other).

As indicated above, one preferred embodiment of the invention is configured such that the trimmer comprises a two-sided movable blade that cooperates with two fixed cutting edges or blades on the jig. The two-sided blade is movable, or more particularly, pivotable, such that it can be first pivoted or moved to one side, for example in a stuffing and trimming action on a wire, to cooperate with a fixed blade or cutting edge on the jig to trim a cable core located inbetween. Subsequently, the knife is pivoted or moved to the other side of the tool (for example by a suitable guide cooperating with a pin of the tool) to trim, in cooperation with another fixed blade on said other side of the tool, a second cable core. An advantage of this embodiment is that the force needed to trim two cable cores is relatively slight, although the stroke may be somewhat longer.

Alternatively, the stroke can be maintained short, although this necessitates a somewhat higher force for trimming, by a second preferred embodiment. In the second embodiment, at least two movable knives or blades are provided which cooperate with at least one fixed knife or blade on the jig. In other words, two blades are moved, or more particularly, pivoted, to one or more fixed cutting edges on the jig such that trimming occurs simultaneously or practically simultaneously. The embodiment may have two, separate fixed cutting edges, each of which cooperates with one of the movable knives or blades. However, it is preferred that a single fixed, double-sided knife or blade cooperating with two movable blades be used. The two movable blades can be moved in an inward direction (i.e. towards each other) toward a fixed, double-sided blade to trim the cable cores on both sides.

### BRIEF DESCRIPTION OF THE DRAWINGS

One embodiment of the invention will now be described in greater detail with reference to the sole FIGURE, a perspective view of the trimmer portion of a termination tool in accordance with the invention.

### DETAILED DESCRIPTION OF A PREFERRED EMBODIMENT OF THE INVENTION

The FIGURE depicts only the jig part 26 and trimmer 10 of the termination tool. It is understood, however, that in addition to the trough-like recesses 12 whose function will be detailed later, the jig 26 may be provided with further guide means, for example in a dual arrangement, so that two cable cores can be located in the jig 26 and stuffed into the contacts of a telecommunications module. The trimmer depicted in the FIGURE can substantially function as described below.

There is provided on the termination tool a shifting element including a pin which is guided in a cam guide 14. When the jig 26 with stops configured at its front end is fully homed in a telecommunications module, as is the case when the cable cores are completely stuffed into their corresponding contacts, the applied further pressure of the handle of the termination tool shifts the pin in the guide 14 so that the movable blade 16 is pivoted about a fulcrum 24. The blade 16 is configured at its front end (at the top as shown in the FIGURE) with cutting edges 18 on both sides. The edges 28 of recesses 12, with which the blade 16 cooperates, are similarly configured with fixed cutting edges 28, with which the blade 16 cooperates. The movable blade 16 is then pivoted by the pin (not shown) being moved upwards in the guide 14. Since the pin cannot be shifted laterally, the extent of the guide—starting roughly from the middle, to the left as shown in the FIGURE, at the point 20—results in the rear part of the movable blade 16 being pivoted to the right. This results in the front part being pivoted to the left due to rotation about the fulcrum 24. The cutting edge 18 of the movable blade 16 is thus moved to the left along the fixed part and the cutting edges 28 of the recesses 12 such that a cable core located in the recess 12 is trimmed by a scissors-like action. The guide runs from the “bulge” 20 of the guide 14 to the left roughly back to the middle so that the blade 16 is moved at least temporarily back to the middle. Starting from the middle, the guide 14 is then slightly deflected to the right up to the end 22 so that the further shift of the pin results in the rear end of the movable blade 16 being pivoted to the left and thus the front cutting edge 18 to the right. This causes the cutting edge 18 to pass the cutting edge 28 of the right-hand recess 12 on the right such that a cable core located therein is trimmed. The pressure on the jig 26 is then released so that the pin of the shifting part slides back through the guide 14 to return the trimmer to its starting position as shown in the FIGURE.

Accordingly, two cable cores can be trimmed to length in a single operation by the movable blade 16 being pivoted first to the one side and then to the other.

The embodiment shown in the FIGURE can be modified by the movable blade 16 likewise comprising at its front end two recesses with cutting edges similar to the recesses 12 of the fixed part. In such a case, once-only pivoting of the movable blade 16 to one side allows the cutting edges of each of the two cooperating recesses working together to trim the cable core located between them. One such trimmer is able to trim two cable cores with a shorter stroke, but necessitating a higher force for trimming. This applies likewise for the embodiment (not shown in the FIGURE) having two, outwardly movable blades, that can move substantially simultaneously toward inner fixed blades to simultaneously make two trims. It is, of course, just as possible to configure each of the guides of the two movable blades so that trimming does not occur precisely at the same time, enabling a relatively short stroke to be combined with relatively little effort (due to the sequence in trimming) in this embodiment.

1. A termination tool for terminating cable cores in telecommunications module contacts, comprising
a handle,
a jig for receiving the cores and stuffing them into a contact, and
a trimmer (10) on said jig,
characterized in that said trimmer (10) is at least double-acting, so that at least two cable cores can be trimmed to length in a single operation.

2. The termination tool as set forth in claim 1, characterized in that said trimmer (10) comprises at least one movable blade (16) which cooperates with at least one fixed edge on the jig.

3. The termination tool as set forth in claim 1 or 2, characterized in that said trimmer (10) comprises a double-sided movable blade (16) which cooperates with two, fixed edges on the jig.

4. The termination tool as set forth in claim 1 or 2, characterized in that said trimmer (10) comprises at least two, movable, blades which cooperate with at least one, fixed edge on the jig.

5. The termination tool as set forth in claim 4, characterized in that one fixed knife is provided which is double-sided.
